(19) United States
(12) Patent Application Publication
(10) Pub. No.: US 2026/0077579 A1
(43) Pub. Date: Mar. 19, 2026

(54) FILM PEELING DEVICE AND FILM PEELING EQUIPMENT INCLUDING THE SAME

(71) Applicant: Samsung Display Co., LTD., Yongin-si (KR)

(72) Inventors: Min Seok KANG, Yongin-si (KR); Tetsuya OKAMOTO, Yongin-si (KR); Hong Chul SHIN, Yongin-si (KR)

(73) Assignee: Samsung Display Co., LTD., Yongin-si (KR)

(21) Appl. No.: 19/027,627

(22) Filed: Jan. 17, 2025

(30) Foreign Application Priority Data
Sep. 19, 2024 (KR) 10-2024-0126689

(51) Int. Cl. B32B 43/00

(52) U.S. Cl. CPC B32B 43/006; B32B 2457/20

(57) ABSTRACT

Provided are a film peeling device and a film peeling equipment including the same. A film peeling device and a film peeling equipment including the film peeling device are able to be coupled a plurality of points of a film attached to a display panel to peel the film.

### CROSS-REFERENCE TO RELATED APPLICATION(S)

This application claims priority to and benefits of Korean Patent Application No. 10-2024-0126689 under 35 U.S.C. § 119, filed on Sep. 19, 2024, in the Korean Intellectual Property Office, the entire contents of which are incorporated herein by reference.

### BACKGROUND

### 1. Technical Field

The disclosure generally relates to a film peeling device and a film peeling equipment including the film peeling device.

### 2. Description of the Related Art

A film may be attached to a display panel. When the display panel is curved at its edge, if the film is separated from the display panel only in one direction, a pressure may be concentrated on one point of the edge of the display panel, thereby causing damage to the display panel.

### SUMMARY

An object of the disclosure is to provide a film peeling device and a film peeling equipment including the same which are coupled to a plurality of points of a film attached to a display panel to peel the film.

According to an aspect of the disclosure, there is provided a film peeling device including a frame module including a center frame, a first wing frame extending forward from the center frame, and a second wing frame extending rearward from the center frame; an elevator module including an elevator body coupled to the center frame and protruding upward from the center frame and an elevator rod coupled to the elevator body to move up the elevator body and down; a first holder module movably disposed on the first wing frame; a second holder module movably disposed on the second wing frame; a first link connecting the first holder module to the elevator rod; and a second link connecting the second holder module to the elevator rod.

In some embodiments, the frame module may further include a third wing frame extending from the center frame to a left and a fourth wing frame extending from the center frame to a right.

In some embodiments, the film peeling device may further include a third holder module movably disposed on the third wing frame, a fourth holder module movably disposed on the fourth wing frame, a third link connecting the third holder module to the elevator rod, and a fourth link connecting the fourth holder module to the elevator rod.

In some embodiments, a length of each of the first wing frame and the second wing frame may be greater than a length of each of the third wing frame and the fourth wing frame, and a length of each of the first link and the second link may be greater than a length of each of the third link and the fourth link.

In some embodiments, a length of each of the first wing frame and the second wing frame may be greater than a length of each of the third wing frame and the fourth wing frame, and an end of each of the first link and the second link may be positioned above an end of each of the third link and the fourth link.

In some embodiments, in case that the elevator rod moves up, the first holder module, the second holder module, the third holder module, and the fourth holder module may move toward the center frame. In case that the elevator rod moves down, the first holder module, the second holder module, the third holder module, and the fourth holder module may move away from the center frame.

In some embodiments, the film peeling device may further include a first guide module coupled to the first wing frame, a second guide module coupled to the second wing frame, a third guide module coupled to the third wing frame, and a fourth guide module coupled to the fourth wing frame. Each of the first guide module, the second guide module, the third guide module, and the fourth guide module may include a guide rail coupled to the frame module and a guide mover movably coupled to the guide rail.

In some embodiments, the first holder module, the second holder module, the third holder module, and the fourth holder module may be coupled to the guide movers of the first guide module, the second guide module, the third guide module, and the fourth guide module, respectively.

In some embodiments, each of the first holder module, the second holder module, the third holder module, and the fourth holder module may include a holder bracket coupled to the guide mover and an end effector protruding downward from the holder bracket.

In some embodiments, the end effector may include an end effector body coupled to the holder bracket, and a suction pad coupled to the end effector body, a suction hole being formed in a face of the suction pad.

In some embodiments, the end effector may include an end effector body coupled to the holder bracket, and a first finger and a second finger which are coupled to the end effector body and move toward or move away from each other.

In some embodiments, the film peeling device may further include an outer frame coupled to the frame module.

In some embodiments, the outer frame may include a plurality of outer column frames coupled to the frame module and each extending upward from the frame module, and an outer top frame coupled to the plurality of outer column frames and positioned above the elevator module.

According to an aspect of the disclosure, there is provided a film peeling device including a frame module including a center frame and a plurality of wing frames respectively extending from the center frame in different directions; an elevator module including an elevator body coupled to the center frame and protruding upward from the center frame and an elevator rod coupled to the elevator body to be able to move up and down; a plurality of holder modules movably disposed on the plurality of wing frames, respectively; and a plurality of links connecting the elevator rod to the plurality of holder modules, respectively, wherein, in case that the elevator rod moves up, the plurality of holder modules move toward the center frame.

In some embodiments, in case that the elevator rod, in a state in which the elevator rod is positioned up, moves down, the plurality of holder modules may move away from the center frame.

In some embodiments, the film peeling device may further include a plurality of guide modules coupled to the plurality of wing frames, respectively. Each of the plurality of guide modules may include a guide rail coupled to the frame module and a guide mover movably coupled to the guide rail.

In some embodiments, each of the plurality of holder modules may include a holder bracket coupled to the guide mover and an end effector protruding downward from the holder bracket.

In some embodiments, the end effector may include an end effector body coupled to the holder bracket, and one of a suction pad and a gripper which are coupled to the end effector body. A suction hole may be formed in a face of the suction pad, and the gripper may include a first finger and a second finger which are coupled to the end effector body and approach or move away from each other.

According to an aspect of the disclosure, there is provided a film peeling equipment including a film peeling device; and a robot coupled to the film peeling device and able to move the film peeling device, wherein the film peeling device includes a frame module including a center frame and a plurality of wing frames respectively extending from the center frame in different directions; an elevator module including an elevator body coupled to the center frame and protruding upward from the center frame and an elevator rod coupled to the elevator body to move the elevator body up and down; a plurality of holder modules movably disposed on the plurality of wing frames, respectively; a plurality of links connecting the elevator rod to the plurality of holder modules, respectively; and an outer frame coupled to the frame module, wherein the robot is coupled to the outer frame, and wherein, in case that the elevator rod moves up, the plurality of holder modules move toward the center frame.

In some embodiments, the robot may include at least one of an articulated robot able to move the film peeling device in a plurality of directions, and an orthogonal robot able to move the film peeling device in one direction.

A film peeling device and a film peeling equipment including the same according to embodiments of the disclosure can be coupled to a plurality of points of a film attached to a display panel to peel the film.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 schematically illustrates a display panel.

FIG. 2 schematically illustrates that a film is attached to a display panel illustrated in FIG. 1.

FIG. 3 schematically illustrates a frame module according to an embodiment of the disclosure.

FIG. 4 schematically illustrates a guide module according to an embodiment of the disclosure.

FIG. 5 schematically illustrates a holder module including a suction unit.

FIG. 6 schematically illustrates a holder module including a gripper.

FIG. 7 schematically illustrates a film peeling device according to an embodiment of the disclosure.

FIG. 8 schematically illustrates that a guide module and an end effector are coupled to a film peeling device illustrated in FIG. 7.

FIG. 9 schematically illustrates that an outer frame is coupled to a frame module illustrated in FIG. 8.

FIG. 10 is a schematic plan view of a film peeling device illustrated in FIG. 9.

FIG. 11 schematically illustrates a cross section of a film peeling device illustrated in FIG. 10 taken along line A1-A2 in case that an elevator rod is in a down-position in the film peeling device.

FIG. 12 schematically illustrates a cross section of a film peeling device illustrated in FIG. 10 taken along line A1-A2 in case that an elevator rod is in an up-position in the film peeling device.

FIG. 13 schematically illustrates a cross section of a film peeling device illustrated in FIG. 10 taken along line B1-B2 in case that an elevator rod in a down-position in the film peeling device.

FIG. 14 schematically illustrates a cross section of a film peeling device illustrated in FIG. 10 taken along line B1-B2 in case that an elevator rod is in an up-position in the film peeling device.

FIG. 15 schematically illustrates that an articulated robot is coupled to a film peeling device illustrated in FIG. 9.

FIG. 16 schematically illustrates that an orthogonal robot is coupled to a film peeling device illustrated in FIG. 9.

### DETAILED DESCRIPTION OF THE EMBODIMENTS

Hereinafter, embodiments of the disclosure will be described in more detail with reference to the accompanying drawings. In the description below, only a necessary part to understand an operation according to the disclosure is described and the descriptions of other parts are omitted in order not to unnecessarily obscure subject matters of the disclosure. In addition, the disclosure is not limited to embodiments described herein, but may be embodied in various different forms. Rather, embodiments described herein are provided to thoroughly and completely describe the disclosed contents and to sufficiently transfer the ideas of the disclosure to a person of ordinary skill in the art.

In the entire specification, in case that an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating a specific embodiment and not intended to limit the embodiment. It will be understood that in case that a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the term, “above,” may encompass both an orientation of above and below. The apparatus may be otherwise oriented (e.g., rotated 90 degrees or at other orientations) and the spatially relative descriptors used herein interpreted accordingly.

In addition, the embodiments of the disclosure are described here with reference to schematic diagrams of ideal embodiments (and an intermediate structure) of the disclosure, so that changes in a shape as shown due to, for example, manufacturing technology and/or a tolerance may be expected. Therefore, the embodiments of the disclosure shall not be limited to the specific shapes of a region shown here, but include shape deviations caused by, for example, the manufacturing technology. The regions shown in the drawings are schematic in nature, and the shapes thereof do not represent the actual shapes of the regions of the device, and do not limit the scope of the disclosure.

A coordinate system may be set in the disclosure. For example, an XYZ coordinate system may be set in the disclosure. The XYZ coordinate system may be, for example, a cartesian coordinate system.

For example, a positive X-axis direction may indicate a forward direction. For example, a negative X-axis direction may indicate a rearward direction. For example, a positive Y-axis direction may indicate a left direction. For example, a negative Y-axis direction may indicate a right direction. For example, a positive Z-axis direction may indicate an upward direction. For example, a negative Z-axis direction may indicate a downward direction.

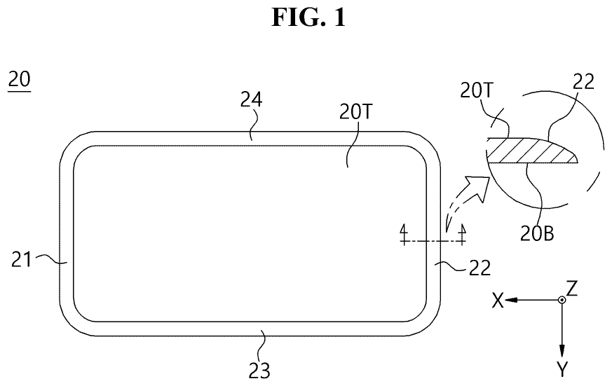

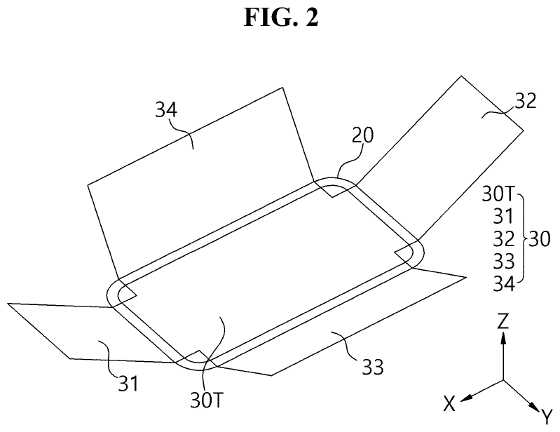

FIG. 1 schematically illustrates a display panel. FIG. 2 schematically illustrates that a film is attached to a display panel illustrated in FIG. 1.

Referring to FIGS. 1 and 2, a display panel 20 may form a panel or plate shape. For example, the display panel 20 may have two faces.

For example, an upper display panel 20T may form a face of the display panel 20. For example, the upper display panel 20T may form an upper face of the display panel 20.

For example, a lower display panel 20B may form another face of the display panel 20. For example, the lower display panel 20B may be formed on the opposite side of the upper display panel 20T.

The display panel 20 may include display panel edge portions 21, 22, 23, and 24. The display panel edge portions 21, 22, 23, and 24 may be bent and extended downward from a perimeter of the upper display panel 20T and may lead to the lower display panel 20B.

The display panel edge portions 21, 22, 23, and 24 may include at least one of a first display panel edge portion 21, a second display panel edge portion 22, a third display panel edge portion 23, and a fourth display panel edge portion 24.

The display panel edge portions 21, 22, 23, and 24 may obliquely face the upward. The display panel edge portions 21, 22, 23, and 24 may be formed or disposed along a perimeter of the display panel 20.

For example, the first display panel edge portion 21 may be formed or disposed along a first edge of the display panel 20. For example, the first edge of the display panel 20 may be a front edge of the display panel 20.

For example, the second display panel edge portion 22 may be formed or disposed along a second edge of the display panel 20. For example, the second edge of the display panel 20 may be a rear edge of the display panel 20.

For example, the third display panel edge portion 23 may be formed or disposed along a third edge of the display panel 20. For example, the third edge of the display panel 20 may be a left edge of the display panel 20.

For example, the fourth display panel edge portion 24 may be formed or disposed along a fourth edge of the display panel 20. For example, the fourth edge of the display panel 20 may be a right edge of the display panel 20.

The display panel 20 may display an image. For example, the upper display panel 20T and the display panel edge portions 21, 22, 23, and 24 may display an image (or images).

A film 30 may be attached to the display panel 20. The film 30 may protect the display panel 20. For example, the film 30 may be detachably attached to the display panel 20.

For example, the film 30 may include an upper film 30T. A shape of the upper film 30T may correspond to a shape of the upper display panel 20T. For example, the shape of the upper film 30T may be a rectangle. An inner face of the upper film 30T may be detachably attached to the upper display panel 20T.

For example, the film 30 may include a first film wing 31. The first film wing 31 may extend forward from a front edge of the upper film 30T.

At least a portion of the first film wing 31 may cover the first display panel edge portion 21. For example, at least a portion of the first film wing 31 may be detachably attached to the first display panel edge portion 21.

For example, the film 30 may include a second film wing 32. The second film wing 32 may extend rearward from a rear edge of the upper film 30T. At least a portion of the second film wing 32 may cover the second display panel edge portion 22. For example, at least a portion of the second film wing 32 may be detachably attached to the second display panel edge portion 22.

For example, the film 30 may include a third film wing 33. The third film wing 33 may extend from a left edge of the upper film 30T. At least a portion of the third film wing 33 may cover the third display panel edge portion 23. For example, at least a portion of the third film wing 33 may be detachably attached to the third display panel edge portion 23.

For example, the film 30 may include a fourth film wing 34. The fourth film wing 34 may extend from a right edge of the upper film 30T. At least a portion of the fourth film wing 34 may cover the fourth display panel edge portion 24. For example, at least a portion of the fourth film wing 34 may be detachably attached to the fourth display panel edge portion 24.

The film wings 31, 32, 33, and 34 may include at least one of the first film wing 31, the second film wing 32, the third film wing 33, and the fourth film wing 34.

The film 30 attached to the display panel 20 needs to be separated from the display panel 20. When the film 30 is detached from the display panel 20 while holding a part of the film wings 31, 32, 33, and 34, a pressure may be concentrated on a point of a portion of the film 30 attached to the display panel edge portions 21, 22, 23, and 24.

Therefore, the film 30 may be detached from the display panel 20 while holding each of the first film wing 31, the second film wing 32, the third film wing 33, and the fourth film wing 34.

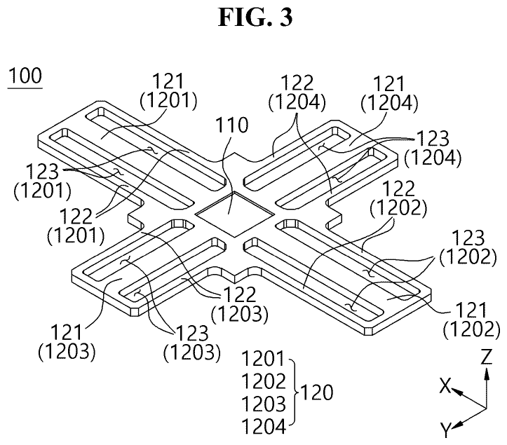

FIG. 3 schematically illustrates a frame module according to an embodiment of the disclosure.

A frame module 100 may include a center frame 110. The center frame 110 may form a central portion of the frame module 100. The center frame 110 may form a face.

For example, the center frame 110 may form an upper face. For example, an upper face of the center frame 110 may be observed in FIG. 3. The upper face of the center frame 110 may be concave.

The frame module 100 may include a wing frame 120. Multiple wing frames 120 may be provided. For example, the frame module 100 may include a first wing frame 1201, a second wing frame 1202, a third wing frame 1203, and a fourth wing frame 1204.

The wing frame 120 may include at least one of the first wing frame 1201, the second wing frame 1202, the third wing frame 1203, and the fourth wing frame 1204.

The wing frame 120 may be connected or coupled to the center frame 110. For example, multiple wing frames 120 may respectively extend from the center frame 110 in different directions.

For example, the wing frame 120 may extend from the center frame 110 in X-axis direction or Y-axis direction. For example, the wing frame 120 may form a shape extending from an end of the center frame 110.

For example, the first wing frame 1201 may extend forward from the center frame 110. For example, the first wing frame 1201 may extend forward from a front end of the center frame 110. For example, the first wing frame 1201 may extend in a positive X-axis direction.

For example, the second wing frame 1202 may extend rearward from the center frame 110. For example, the second wing frame 1202 may extend rearward from a rear end of the center frame 110. For example, the second wing frame 1202 may extend in a negative X-axis direction.

For example, the third wing frame 1203 may extend left from the center frame 110. For example, the third wing frame 1203 may extend left from a left end of the center frame 110. For example, the third wing frame 1203 may extend in a positive Y-axis direction.

For example, the fourth wing frame 1204 may extend right from the center frame 110. For example, the fourth wing frame 1204 may extend right from a right end of the center frame 110. For example, the fourth wing frame 1204 may extend in a negative Y-axis direction.

For example, the first wing frame 1201 and the second wing frame 1202 may be symmetrical with respect to the center frame 110. For example, the first wing frame 1201 and the second wing frame 1202 may be symmetrical in a front-rear direction (e.g., X-axis direction).

For example, the third wing frame 1203 and the fourth wing frame 1204 may be symmetrical with respect to the center frame 110. For example, the third wing frame 1203 and the fourth wing frame 1204 may be symmetrical in a left-right direction (e.g., Y-axis direction).

A longitudinal direction of the wing frame 120 may refer to a direction in which the wing frame 120 extends from the center frame 110. For example, the wing frame 120 may extend from a proximal end of the wing frame 120 and lead to a distal end of the wing frame 120.

The proximal end of the wing frame 120 may be a portion connected to the center frame 110 among both ends of the wing frame 120. The distal end of the wing frame 120 may be positioned opposite the proximal end of the wing frame 120.

A height of each component of the frame module 100 may be set based on the Z-axis. For example, the height of each component of the wing frame 120 may be set based on an upper face of the wing frame 120.

For example, a height of the proximal end of the wing frame 120 may be greater than or equal to a height of the distal end of the wing frame 120.

For example, the first wing frame 1201, the center frame 110, and the second wing frame 1202 may form an overall flat shape. For example, the first wing frame 1201, the center frame 110, and the second wing frame 1202 may form an overall upward convex shape.

For example, the third wing frame 1203, the center frame 110, and the fourth wing frame 1204 may form an overall flat shape. For example, the third wing frame 1203, the center frame 110, and the fourth wing frame 1204 may form an overall upward convex shape.

The wing frame 120 may include a wing road 121. The wing road 121 may be connected or coupled to the center frame 110. For example, the wing road 121 may form a shape extending from the center frame 110.

The wing road 121 may form a shape extending in one direction. For example, an upper face of the wing road 121 may form a shape extending in one direction. For example, the upper face of the wing road 121 may be connected to the upper face of the center frame 110.

For example, the wing road 121 of the first wing frame 1201 may form a shape extending forward from the front end of the center frame 110. For example, the wing road 121 of the second wing frame 1202 may form a shape extending rearward from the rear end of the center frame 110.

For example, the wing road 121 of the third wing frame 1203 may form a shape extending left from the left end of the center frame 110. For example, the wing road 121 of the fourth wing frame 1204 may form a shape extending right from the right end of the center frame 110.

The wing road 121 of the first wing frame 1201 and the wing road 121 of the second wing frame 1202 may be symmetrical in the front-rear direction (e.g., X-axis direction). The wing road 121 of the third wing frame 1203 and the wing road 121 of the fourth wing frame 1204 may be symmetrical in the left-right direction (e.g., Y-axis direction).

The wing frame 120 may include a wing guide 122. The wing guide 122 may be parallel to the wing road 121. For example, a longitudinal direction of the wing guide 122 may be a longitudinal direction of the wing road 121 in the X-axis direction, and a transverse direction of the wing guide 122 may be a transverse direction of the wing road 121 in the Y-axis direction.

An end of the wing guide 122 may be connected or coupled to an end of the wing road 121. For example, a proximal end of the wing guide 122 may be connected or coupled to a proximal end of the wing road 121. For example, a distal end of the wing guide 122 may be connected or coupled to a distal end of the wing road 121.

The wing guide 122 may be connected or coupled to at least one of the wing road 121 and the center frame 110. For example, the wing guide 122 may extend from the center frame 110. For example, the proximal end of the wing guide 122 and the proximal end of the wing road 121 may be connected to the center frame 110.

The wing frame 120 may include a wing slit 123. The wing slit 123 may refer to a space between the wing guide 122 and the wing road 121. For example, the wing slit 123 may be disposed between the wing guide 122 and the wing road 121.

The wing slit 123 may extend in the longitudinal direction of the wing road 121. For example, a longitudinal direction of the wing slit 123 may be the longitudinal direction of the wing road 121 in the X-axis direction, and a transverse direction of the wing slit 123 may be a transverse direction of the wing road 121 in the Y-axis direction.

The wing guide 122 may be provided as a pair. For example, the wing road 121 may be positioned between the pair of wing guides 122. For example, a pair of wing slits 123 may be formed between the wing road 121 and the pair of wing guides 122, respectively.

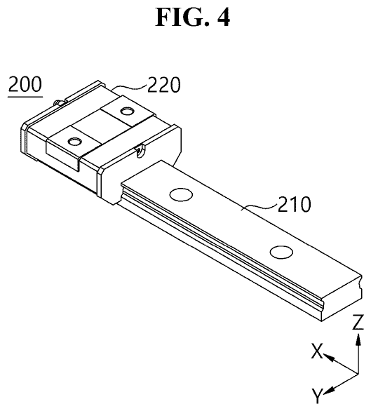

FIG. 4 schematically illustrates a guide module according to an embodiment of the disclosure.

Referring to FIG. 4, a guide module 200 may include a guide rail 210. The guide rail 210 may form a shape extending in a longitudinal direction (e.g., X-axis direction). For example, the guide rail 210 may form the shape of a rail.

The guide rail 210 may be coupled or fixedly attached to the wing frame 120 (see FIG. 3). For example, a lower face of the guide rail 210 may be coupled or fixedly attached to the upper face of the wing road 121 (see FIG. 3).

The guide module 200 may include a guide mover 220. The guide mover 220 may be movably coupled to the guide rail 210. For example, the guide mover 220 may move along the guide rail 210 in the X-axis direction.

The guide mover 220 may be fitted to the guide rail 210. For example, in a state where the guide rail 210 is fixedly attached to the frame module 100 (see FIG. 3) and the guide mover 220 is coupled to the guide rail 210, the movement of the guide mover 220 in a direction intersecting the longitudinal direction of the guide rail 210 can be suppressed.

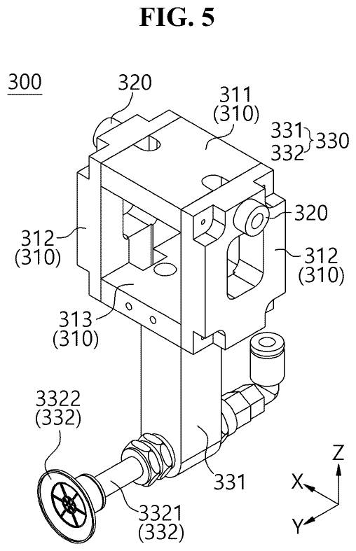

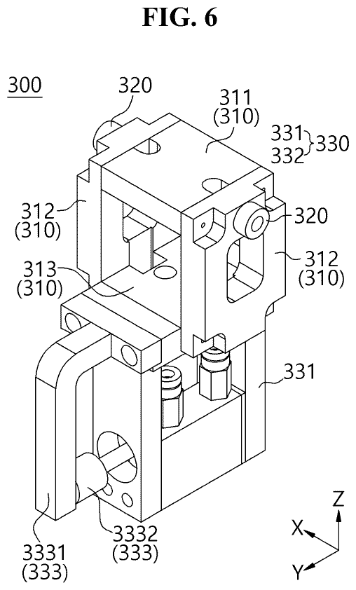

FIG. 5 schematically illustrates a holder module including a suction unit. FIG. 6 schematically illustrates a holder module including a gripper.

Referring to FIGS. 5 and 6, a holder module 300 may include a holder bracket 310. The holder bracket 310 may be coupled to the guide module 200 (see FIG. 4). For example, the holder bracket 310 may be coupled to the guide mover 220 (see FIG. 4).

The holder bracket 310 may include an upper bracket 311. The upper bracket 311 may form an upper face of the holder bracket 310. The upper bracket 311 may be coupled to the guide mover 220 (see FIG. 4). For example, a lower face of the upper bracket 311 may face an upper face of the guide mover 220 (see FIG. 4).

The holder bracket 310 may include a bracket wall 312. The bracket wall 312 may be connected or coupled to the upper bracket 311. For example, the bracket wall 312 may extend downward from the upper bracket 311.

The bracket wall 312 may be positioned in the wing slit 123 (see FIG. 3). For example, the bracket wall 312 may be positioned between the wing road 121 (see FIG. 3) and the wing guide 122 (see FIG. 4).

The bracket wall 312 may be provided as a pair. For example, a pair of bracket walls 312 may face each other. For example, the pair of bracket walls 312 may be respectively positioned in the pair of wing slits 123 (see FIG. 3).

The holder bracket 310 may include a lower bracket 313. The lower bracket 313 may be positioned below the upper bracket 311. The lower bracket 313 may be positioned below the wing road 121 (see FIG. 3).

The lower bracket 313 may be connected or coupled to the bracket wall 312. For example, the lower bracket 313 may connect the pair of bracket walls 312. For example, the lower bracket 313 may be positioned between the pair of bracket walls 312.

The lower bracket 313, the bracket walls 312, and the upper bracket 311 may be sequentially connected. For example, the lower bracket 313, the bracket walls 312, and the upper bracket 311 may be integrally formed.

The holder module 300 may include a bracket coupler 320. The bracket coupler 320 may be installed, coupled, or fixedly attached to the holder bracket 310. For example, the bracket coupler 320 may be coupled to the bracket wall 312 to fixedly attach the upper bracket 311 to the bracket wall 312.

For example, the bracket coupler 320 may form a shape extending from the bracket wall 312. A central portion of an outer face of the bracket coupler 320 may be recessed.

The holder module 300 may include an end effector 330. The end effector 330 may be coupled to the holder bracket 310. The end effector 330 may be positioned below the wing frame 120 (see FIG. 3).

For example, the end effector 330 may include an end effector body 331 that forms a shape extending from the holder bracket 310. For example, the end effector body 331 may be coupled or connected to the lower bracket 313.

Referring to FIG. 5, the end effector 330 may include a suction unit 332. The suction unit 332 may include a suction rod 3321. The suction rod 3321 may be connected or coupled to the end effector body 331.

The suction rod 3321 may form the shape of a pipe or tube. An end of the suction rod 3321 may be connected to a vacuum pump (not shown).

The suction unit 332 may include a suction pad 3322. The suction pad 3322 may be connected or coupled to the suction rod 3321. For example, an end of the suction rod 3321 may be connected or coupled to the end effector body 331, and another end of the suction rod 3321 may be connected or coupled to the suction pad 3322. For example, the suction pad 3322 may be positioned between the end effector body 331 and the suction pad 3322.

In case that the vacuum pump (not shown) operates, an internal pressure of the suction rod 3321 may be reduced. For example, in case that the vacuum pump (not shown) operates, the internal pressure of the suction rod 3321 may be lower than an external air pressure of the suction unit 332.

A suction hole (not shown) may be formed in a face of the suction pad 3322. In case that the internal pressure of the suction rod 3321 is lower than the external air pressure of the suction unit 332, air positioned around the suction pad 3322 may enter the inside of the suction pad 3322 through the suction hole (not shown).

For example, in case that the vacuum pump (not shown) operates in a state where the suction hole (not shown) of the suction pad 3322 faces the film wings 31, 32, 33, and 34 (see FIG. 2), the film wings 31, 32, 33, and 34 (see FIG. 2) may be sucked on the suction pad 3322.

Referring to FIG. 6, the end effector 330 may include a gripper 333. Multiple grippers 333 may be provided. For example, the end effector 330 may include a first finger 3331 and a second finger 3332. The gripper 333 may include at least one of the first finger 3331 and the second finger 3332.

The gripper 333 may be connected or coupled to at least one of the end effector body 331 and the holder bracket 310. For example, the gripper 333 may be connected or coupled to the end effector body 331.

For example, at least one of the first finger 3331 and the second finger 3332 may move. For example, at least one of the first finger 3331 and the second finger 3332 may be movably coupled to the end effector body 331.

For example, the first finger 3331 may be fixedly attached to the end effector body 331, and at least a portion of the second finger 3332 may be movably coupled to the end effector body 331.

For example, the first finger 3331 and the second finger 3332 may approach or move away from each other. For example, in case that the first finger 3331 and the second finger 3332 approach each other in a state where the film wings 31, 32, 33, and 34 (see FIG. 2) are positioned between the first finger 3331 and the second finger 3332, the film wings 31, 32, 33, and 34 (see FIG. 2) may be fixedly attached to the gripper 333.

For example, in case that the first finger 3331 and the second finger 3332 move away from each other in a state where the film wings 31, 32, 33, and 34 (see FIG. 2) are fixedly attached to the gripper 333, the film wings 31, 32, 33, and 34 (see FIG. 2) may be separated from the gripper 333.

Referring to FIGS. 5 and 6, the end effector 330 may be detachably coupled to the holder bracket 310. For example, the end effector 330 including the suction unit 332 and the end effector 330 including the gripper 333 may be interchangeable. Therefore, one of the end effector 330 including the suction unit 332 and the end effector 330 including the gripper 333 may be selected depending on a situation.

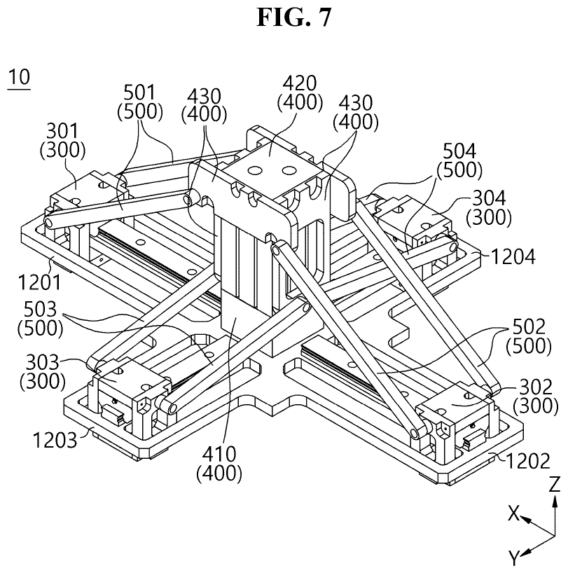

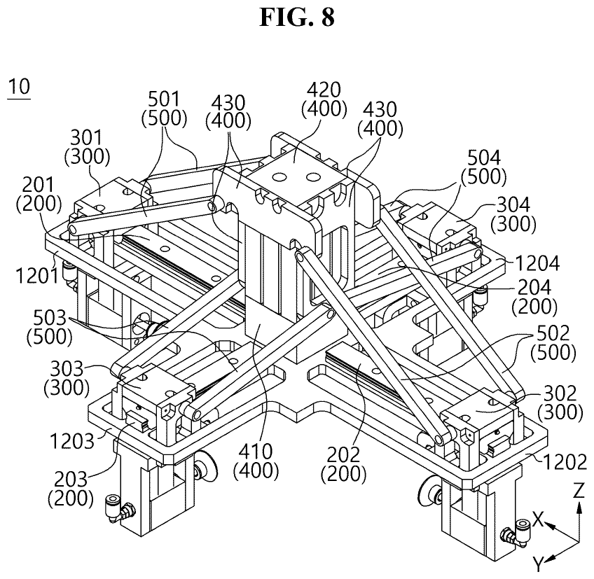

FIG. 7 schematically illustrates a film peeling device according to an embodiment of the disclosure. FIG. 8 schematically illustrates that a guide module and an end effector are coupled to a film peeling device illustrated in FIG. 7.

Referring to FIG. 7, a film peeling device 10 may include the frame module 100 illustrated in FIG. 3. The film peeling device 10 may include the holder bracket 310 and the bracket coupler 320 of the holder module 300 illustrated in FIGS. 5 and 6.

Referring to FIGS. 3 to 8, multiple holder modules 300 may be provided. For example, the film peeling device 10 may include a first holder module 301, a second holder module 302, a third holder module 303, and a fourth holder module 304.

Multiple guide modules 200 may be provided. For example, the film peeling device 10 may include a first guide module 201, a second guide module 202, a third guide module 203, and a fourth guide module 204.

The guide module 200 may include at least one of the first guide module 201, the second guide module 202, the third guide module 203, and the fourth guide module 204.

The guide module 200 may be coupled to or installed on the wing frame 120. For example, the guide rail 210 may be coupled to the wing road 121. The guide module 200 may be coupled to the holder module 300. For example, the guide mover 220 may be coupled to the holder bracket 310.

For example, the first guide module 201 may be coupled to the first wing frame 1201. For example, the first guide module 201 may be coupled to the first holder module 301.

For example, the second guide module 202 may be coupled to the second wing frame 1202. For example, the second guide module 202 may be coupled to the second holder module 302.

For example, the third guide module 203 may be coupled to the third wing frame 1203. For example, the third guide module 203 may be coupled to the third holder module 303.

For example, the fourth guide module 204 may be coupled to the fourth wing frame 1204. For example, the fourth guide module 204 may be coupled to the fourth holder module 304.

The holder module 300 may include at least one of the first holder module 301, the second holder module 302, the third holder module 303, and the fourth holder module 304.

The holder module 300 may be coupled to the frame module 100. For example, the holder bracket 310 may be coupled to the wing frame 120. For example, the wing road 121 may penetrate the holder bracket 310 or be inserted into the holder bracket 310.

For example, the wing road 121 may be positioned between the upper bracket 311 and the lower bracket 313. For example, the wing road 121 may be positioned between the pair of bracket walls 312.

For example, the holder bracket 310 may be attached to the wing frame 120. For example, the bracket wall 312 may be positioned in the wing slit 123. For example, the bracket wall 312 may be positioned between the wing road 121 and the wing guide 122.

For example, the holder bracket 310 of the first holder module 301 may be coupled to the first wing frame 1201. For example, the holder bracket 310 of the second holder module 302 may be coupled to the second wing frame 1202. For example, the holder bracket 310 of the third holder module 303 may be coupled to the third wing frame 1203. For example, the holder bracket 310 of the fourth holder module 304 may be coupled to the fourth wing frame 1204.

The film peeling device 10 may include an elevator module 400. For example, the elevator module 400 may be positioned between the first holder module 301 and the second holder module 302. For example, the elevator module 400 may be positioned between the third holder module 303 and the fourth holder module 304.

The elevator module 400 may include an elevator body 410. The elevator body 410 may be coupled to or fixedly attached to the center frame 110. The elevator body 410 may form a shape that extends or protrudes upward from the upper face of the center frame 110. The elevator body 410 may form the shape of a cylinder bore.

The elevator module 400 may include an elevator rod 420. As depicted in FIG. 7, an upper end of the elevator rod 420 may be observed. The elevator rod 420 may be coupled to the elevator body 410.

For example, the elevator rod 420 may be coupled to the elevator body 410 to be able to move up and down.

For example, the elevator rod 420 may be coupled to the elevator body 410 to be able to move up and down by an air pressure or an oil pressure.

For example, in case that a pressure between the elevator body 410 and the elevator rod 420 increases, the elevator rod 420 may move up, and in case that the pressure between the elevator body 410 and the elevator rod 420 decreases, the elevator rod 420 may move down.

For another example, the elevator rod 420 may be coupled to the elevator body 410 to be able to move up and down by an electric motor. For example, the elevator module 400 may include an electric motor (not shown) and a gear assembly (not shown).

For example, the gear assembly (not shown) may include a pinion gear (not shown) and a rack gear (not shown). The rack gear (not shown) may be coupled to the elevator rod 420. The pinion gear (not shown) may be coupled to the electric motor (not shown). The elevator rod 420 may move up and down depending on a direction of rotation of the electric motor (not shown).

The film peeling device 10 may include a link module 500. Multiple link modules 500 may be provided. For example, the film peeling device 10 may include a first link 501, a second link 502, a third link 503, and a fourth link 504.

The link module 500 may include at least one of the first link 501, the second link 502, the third link 503, and the fourth link 504. The link module 500 may have rigidity. Multiple links 501, 502, 503, and 504 may include at least one of the first link 501, the second link 502, the third link 503, and the fourth link 504.

The elevator module 400 may include an elevator fastening unit 430. The elevator fastening unit 430 may be connected or coupled to the elevator rod 420. For example, the elevator fastening unit 430 and the elevator rod 420 may be formed integrally.

For example, as the elevator rod 420 moves up and down, the elevator fastening unit 430 may move up and down.

The link module 500 may connect the elevator module 400 to the holder module 300. For example, an end of the link module 500 may be pivotably coupled to the holder module 300. For example, another end of the link module 500 may be pivotably coupled to the elevator module 400.

For example, an end of the first link 501 may be pivotably coupled to the bracket coupler 320 of the first holder module 301. For example, another end of the first link 501 may be pivotably coupled to the elevator fastening unit 430.

For example, an end of the second link 502 may be pivotably coupled to the bracket coupler 320 of the second holder module 302. For example, another end of the second link 502 may be pivotably coupled to the elevator fastening unit 430.

For example, an end of the third link 503 may be pivotably coupled to the bracket coupler 320 of the third holder module 303. For example, another end of the third link 503 may be pivotably coupled to the elevator fastening unit 430.

For example, an end of the fourth link 504 may be pivotably coupled to the bracket coupler 320 of the fourth holder module 304. For example, another end of the fourth link 504 may be pivotably coupled to the elevator fastening unit 430.

The first link 501 and the second link 502 may be arranged symmetrically. The third link 503 and the fourth link 504 may be arranged symmetrically. A length and a position of each of the first link 501, the second link 502, the third link 503, and the fourth link 504 may vary depending on a length of the wing frame 120.

For example, a length of the link module 500 coupled to the holder module 300 positioned on the relatively long wing frame 120 may be greater (longer) than a length of the link module 500 coupled to the holder module 300 positioned on the relatively short wing frame 120.

For example, a length of each of the first wing frame 1201 and the second wing frame 1202 may be greater (longer) than a length of each of the third wing frame 1203 and the fourth wing frame 1204. For example, a length of each of the first link 501 and the second link 502 may be greater (longer) than a length of each of the third link 503 and the fourth link 504.

For example, the link module 500 coupled to the holder module 300 positioned on the relatively long wing frame 120 may be positioned above the link module 500 coupled to the holder module 300 positioned on the relatively short wing frame 120.

For example, the length of each of the first wing frame 1201 and the second wing frame 1202 may be greater (longer) in the X-axis direction than the length of each of the third wing frame 1203 and the fourth wing frame 1204 in the Y-axis direction. For example, the first link 501 and the second link 502 may be positioned above the third link 503 and the fourth link 504. For example, an end of the first link 501 and an end of the second link 502 may be positioned above an end of the third link 503 and an end of the fourth link 504.

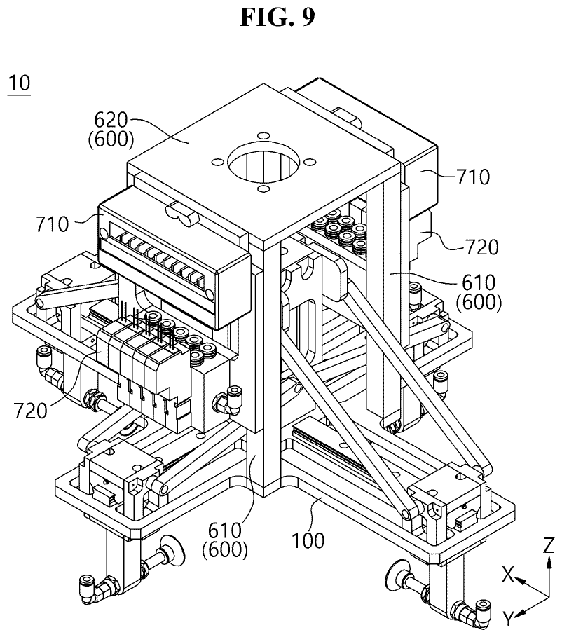

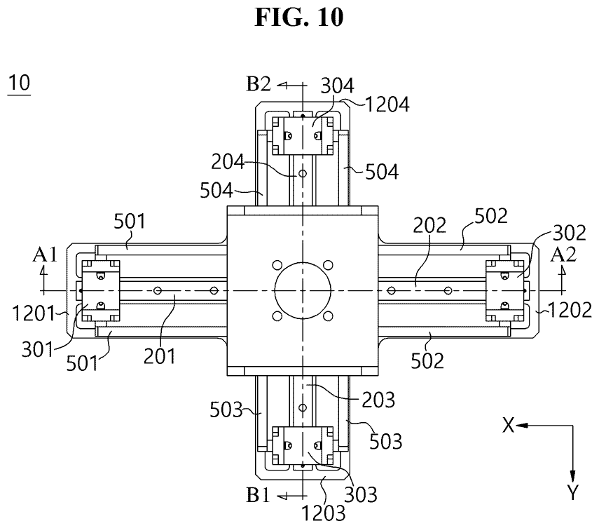

FIG. 9 schematically illustrates that an outer frame is coupled to a frame module illustrated in FIG. 8. FIG. 10 is a schematic plan view of a film peeling device illustrated in FIG. 9. As depicted in FIG. 10, at least one of components 710 and 720 may be omitted for convenience of explanation.

Referring to FIGS. 8 to 10, the film peeling device 10 may include an outer frame 600. The outer frame 600 may be coupled or fixedly attached to the frame module 100.

For example, the outer frame 600 may include an outer column frame 610. The outer column frame 610 may be coupled or fixedly attached to the frame module 100.

The outer column frame 610 may form a shape extending upward from the frame module 100. Multiple outer column frames 610 may be provided. For example, the outer frame 600 may include multiple outer column frames 610.

Multiple outer column frames 610 may be arranged at a perimeter of the center frame 110 (see FIG. 3). For example, multiple outer column frames 610 may be arranged at a perimeter of the elevator module 400.

The outer frame 600 may include an outer top frame 620. The outer top frame 620 may be positioned above the elevator module 400. The outer top frame 620 may form an upper face of the film peeling device 10.

The outer top frame 620 may be connected or coupled to the outer column frames 610. For example, the outer top frame 620 and the outer column frames 610 may be formed integrally.

The film peeling device 10 may include at least one of components 710 and 720. For example, the film peeling device 10 may include a first component 710 and a second component 720.

The first component 710 and the second component 720 may be coupled to the outer frame 600. For example, the first component 710 and the second component 720 may be coupled to the outer column frame 610.

The first component 710 may be connected to the elevator module 400 and the holder module 300. For example, the first component 710 may be connected to a sensor (not shown) for detecting the operation of the elevator module 400 and receive a signal. For example, the first component 710 may be connected to a sensor (not shown) for detecting the operation of the holder module 300 and receive a signal.

For example, the first component 710 may transmit the received signals to a controller (not shown). The controller (not shown) may control at least one of the elevator module 400 and the holder module 300 based on the signals received from the first component 710.

The second component 720 may be connected to at least one of the elevator module 400 and the holder module 300. For example, the second component 720 may include a solenoid valve. For example, the second component 720 may drive at least one of the elevator module 400 and the holder module 300.

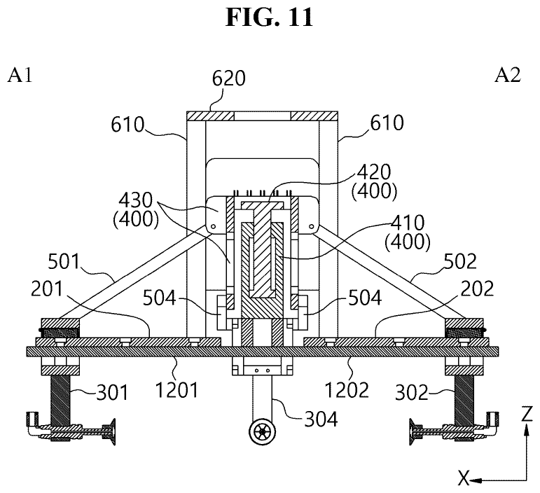

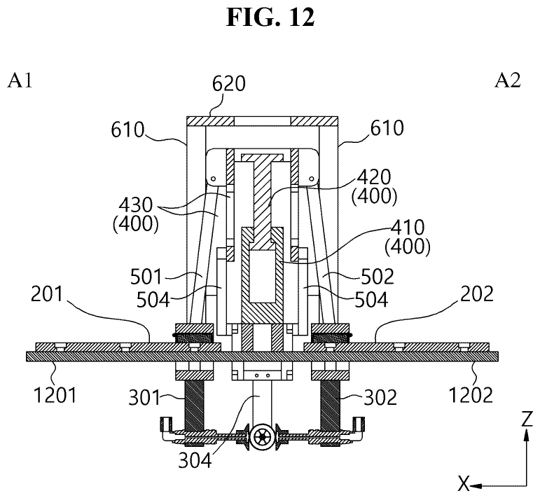

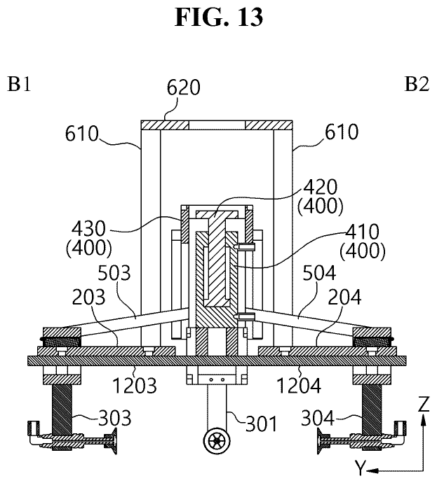

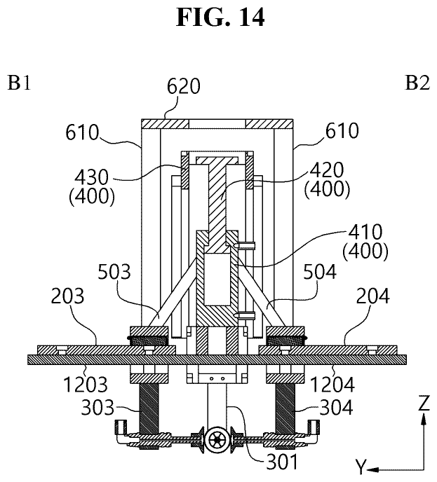

FIG. 11 schematically illustrates a cross section of a film peeling device illustrated in FIG. 10 taken along line A1-A2 in case that an elevator rod in a down-position in the film peeling device. FIG. 12 schematically illustrates a cross section of a film peeling device illustrated in FIG. 10 taken along line A1-A2 in case that an elevator rod is in an up-position in the film peeling device. FIG. 13 schematically illustrates a cross section of a film peeling device illustrated in FIG. 10 taken along line B1-B2 in case that an elevator rod is in a down-position in the film peeling device. FIG. 14 schematically illustrates a cross section of a film peeling device illustrated in FIG. 10 taken along line B1-B2 in case that an elevator rod is in an up-position in the film peeling device.

Referring to FIGS. 11 to 14, the holder module 300 may grip the film 30 (see FIG. 2). For example, the first holder module 301 may grip the first film wing 31 (see FIG. 2). For example, the second holder module 302 may grip the second film wing 32 (see FIG. 2). For example, the third holder module 303 may grip the third film wing 33 (see FIG. 2). For example, the fourth holder module 304 may grip the fourth film wing 34 (see FIG. 2).

The elevator module 400 may operate. For example, the elevator rod 420 may move up and down with respect to the elevator body 410. For example, at least a portion of the elevator rod 420 may move up and down with respect to the elevator body 410 in the Z-axis direction.

In case that the elevator rod 420 moves up, the elevator fastening unit 430 may move up. In case that the elevator rod 420 moves down, the elevator fastening unit 430 may move down.

In case that the elevator fastening unit 430 moves up, an upper end of the link module 500 may move up. In case that the upper end of the link module 500 moves up, an upward force may be applied to a lower end of the link module 500.

A portion of the upward force applied to the lower end of the link module 500 may be converted to a longitudinal direction of the link module 500. For example, a force directed from the lower end to the upper end of the link module 500 may be formed in the link module 500.

A portion of the force directed from the lower end to the upper end of the link module 500 may be transferred to the holder module 300. A moving direction of the holder module 300 may be limited to a moving direction of the guide mover 220 (see FIG. 4).

Accordingly, in case that the elevator fastening unit 430 moves up, the holder module 300 and the guide mover 220 may move toward the center frame 110 (see FIG. 3). In case that the elevator fastening unit 430 moves up in a state where the holder module 300 grips the film wings 31, 32, 33, and 34 (see FIG. 2), at least a portion of the film 30 (see FIG. 3) may be peeled from the display panel 20 (see FIG. 3).

For another example, in case that the elevator fastening unit 430, in a state in which the elevator fastening unit 430 is positioned up, moves down, the holder module 300 and the guide mover 220 may move away from the center frame 110 (see FIG. 3).

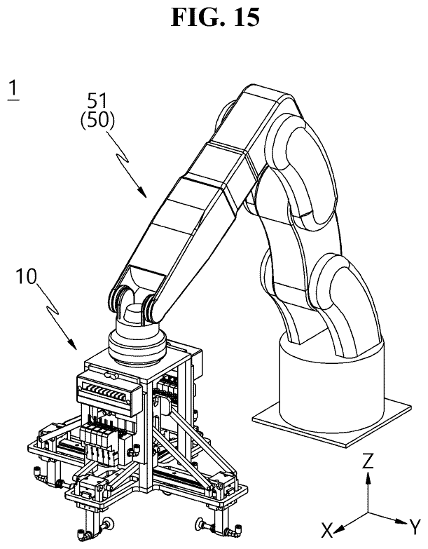

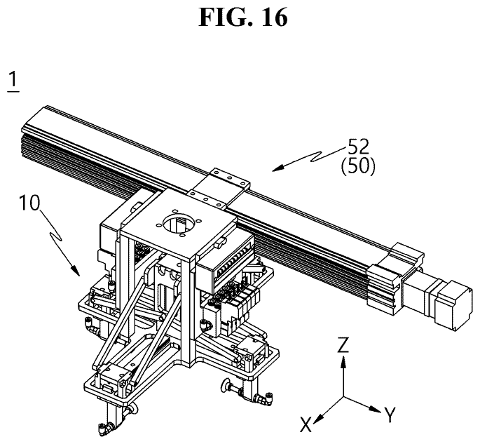

FIG. 15 schematically illustrates that an articulated robot is coupled to a film peeling device illustrated in FIG. 9. FIG. 16 schematically illustrates that an orthogonal robot is coupled to a film peeling device illustrated in FIG. 9.

Referring to FIGS. 1 to 16, a film peeling equipment 1 may include the film peeling device 10 and a robot 50. The robot 50 may be coupled to the film peeling device 10.

After the film peeling device 10 peels a portion of the film 30 from the display panel 20, the robot 50 may peel a remainder of the film 30 from the display panel 20.

For example, after the film peeling device 10 peels a portion of the film 30 from the display panel 20, the robot 50 may move the film peeling device 10 to peel the remainder of the film 30 from the display panel 20.

Referring to FIGS. 1 to 15, the robot 50 may include an articulated robot 51. The articulated robot 51 may include multiple joints. The degree of freedom of the articulated robot 51 may be 3 or more.

The articulated robot 51 may be coupled to the outer frame 600. For example, the articulated robot 51 may be coupled to the outer top frame 620. The articulated robot 51 may move the film peeling device 10 in multiple directions.

Referring to FIGS. 1 to 14 and 16, the robot 50 may include an orthogonal robot 52. The orthogonal robot 52 may be coupled to the outer frame 600. For example, the orthogonal robot 52 may be coupled to the outer column frame 610. The orthogonal robot 52 may move the film peeling device 10 in one direction. For example, the orthogonal robot 52 may move the film peeling device 10 in the Y-axis direction.

However, the effects of the disclosure are not restricted to the one set forth herein. The above and other effects of the disclosure will become more apparent to one of daily skill in the art to which the disclosure pertains by referencing the claims. The above description is an example of technical features of the disclosure, and those skilled in the art to which the disclosure pertains will be able to make various modifications and variations. Thus, the embodiments of the disclosure described above may be implemented separately or in combination with each other.

The embodiments disclosed in the disclosure are intended not to limit the technical spirit of the disclosure but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A film peeling device comprising:
a frame module including a center frame, a first wing frame extending forward from the center frame, and a second wing frame extending rearward from the center frame;
an elevator module including an elevator body coupled to the center frame and protruding upward from the center frame and an elevator rod coupled to the elevator body to move the elevator body up and down;
a first holder module movably disposed on the first wing frame;
a second holder module movably disposed on the second wing frame;
a first link connecting the first holder module to the elevator rod; and
a second link connecting the second holder module to the elevator rod.

2. The film peeling device of claim 1, wherein the frame module further includes:
a third wing frame extending from the center frame to a left; and
a fourth wing frame extending from the center frame to a right.

3. The film peeling device of claim 2, further comprising:
a third holder module movably disposed on the third wing frame;
a fourth holder module movably disposed on the fourth wing frame;
a third link connecting the third holder module to the elevator rod; and
a fourth link connecting the fourth holder module to the elevator rod.

4. The film peeling device of claim 3, wherein a length of each of the first wing frame and the second wing frame is greater than a length of each of the third wing frame and the fourth wing frame, and
a length of each of the first link and the second link is greater than a length of each of the third link and the fourth link.

5. The film peeling device of claim 3, wherein a length of each of the first wing frame and the second wing frame is greater than a length of each of the third wing frame and the fourth wing frame, and
an end of each of the first link and the second link is positioned above an end of each of the third link and the fourth link.

6. The film peeling device of claim 3, wherein, in case that the elevator rod moves up, the first holder module, the second holder module, the third holder module, and the fourth holder module move toward the center frame, and
in case that the elevator rod moves down, the first holder module, the second holder module, the third holder module, and the fourth holder module move away from the center frame.

7. The film peeling device of claim 3, further comprising:
a first guide module coupled to the first wing frame;
a second guide module coupled to the second wing frame;
a third guide module coupled to the third wing frame; and
a fourth guide module coupled to the fourth wing frame,
wherein each of the first guide module, the second guide module, the third guide module, and the fourth guide module includes:
a guide rail coupled to the frame module; and
a guide mover movably coupled to the guide rail.

8. The film peeling device of claim 7, wherein the first holder module, the second holder module, the third holder module, and the fourth holder module are coupled to the guide movers of the first guide module, the second guide module, the third guide module, and the fourth guide module, respectively.

9. The film peeling device of claim 8, wherein each of the first holder module, the second holder module, the third holder module, and the fourth holder module includes:
a holder bracket coupled to the guide mover; and
an end effector protruding downward from the holder bracket.

10. The film peeling device of claim 9, wherein the end effector includes:
an end effector body coupled to the holder bracket;
a suction pad coupled to the end effector body; and
a suction hole being formed in a face of the suction pad.

11. The film peeling device of claim 9, wherein the end effector includes:
an end effector body coupled to the holder bracket; and
a first finger and a second finger which are coupled to the end effector body and move toward or move away from each other.

12. The film peeling device of claim 1, further comprising an outer frame coupled to the frame module.

13. The film peeling device of claim 12, wherein the outer frame includes:
a plurality of outer column frames coupled to the frame module, each of the plurality of outer column frames extending upward from the frame module; and
an outer top frame coupled to the plurality of outer column frames and positioned above the elevator module.

14. A film peeling device comprising:
a frame module including a center frame and a plurality of wing frames respectively extending from the center frame in different directions;
an elevator module including an elevator body coupled to the center frame and protruding upward from the center frame and an elevator rod coupled to the elevator body to be able to move up and down;
a plurality of holder modules movably disposed on the plurality of wing frames, respectively; and
a plurality of links connecting the elevator rod to the plurality of holder modules, respectively,
wherein, in case that the elevator rod moves up, the plurality of holder modules move toward the center frame.

15. The film peeling device of claim 14, wherein, in case that the elevator rod, in a state in which the elevator rod is positioned up, moves down, the plurality of holder modules move away from the center frame.

16. The film peeling device of claim 14, further comprising a plurality of guide modules coupled to the plurality of wing frames, respectively,
wherein each of the plurality of guide modules includes:
a guide rail coupled to the frame module; and
a guide mover movably coupled to the guide rail.

17. The film peeling device of claim 16, wherein each of the plurality of holder modules includes:
a holder bracket coupled to the guide mover; and
an end effector protruding downward from the holder bracket.

18. The film peeling device of claim 17, wherein the end effector includes:
an end effector body coupled to the holder bracket; and
one of a suction pad and a gripper which are coupled to the end effector body,
wherein a suction hole is formed in a face of the suction pad, and
the gripper includes a first finger and a second finger which are coupled to the end effector body and approach or move away from each other.

19. A film peeling equipment comprising:
a film peeling device; and
a robot coupled to the film peeling device and able to move the film peeling device,
wherein the film peeling device includes:
a frame module including a center frame and a plurality of wing frames respectively extending from the center frame in different directions;
an elevator module including an elevator body coupled to the center frame and protruding upward from the center frame and an elevator rod coupled to the elevator body to move the elevator body up and down;
a plurality of holder modules movably disposed on the plurality of wing frames, respectively;
a plurality of links connecting the elevator rod to the plurality of holder modules, respectively; and
an outer frame coupled to the frame module,
the robot is coupled to the outer frame, and
in case that the elevator rod moves up, the plurality of holder modules move toward the center frame.

20. The film peeling equipment of claim 19, wherein the robot includes at least one of:
an articulated robot able to move the film peeling device in a plurality of directions; and
an orthogonal robot able to move the film peeling device in one direction.
